(19) United States
(12) Patent Application Publication
(10) Pub. No.: US 2008/0285487 A1
(43) Pub. Date: Nov. 20, 2008

(54) METHOD AND SYSTEM FOR PROVIDING FULL DUPLEX SERVICES OVER MULTIPLE SIMPLEX MEDIA PATHS AND SESSIONS

(76) Inventors: Jan Forslow, San Mateo, CA (US); Karl Mutch, Stanford, CA (US); Johan Samuelsson, Redwood City, CA (US)

Correspondence Address: KALI LAW GROUP, P. C, P.O. BOX 60187, SUNNYVALE, CA, 94088-0187, US

(21) Appl. No.: 11/747,096

(22) Filed: May 10, 2007

Related U.S. Application Data
(60) Provisional application No. 60/799,270, filed on May 10, 2006.

(51) Int. Cl. H04B 7/00

(52) U.S. Cl. 370/277

(57) ABSTRACT

Methods for providing full duplex media service over a communications network employing simplex media paths are presented including: establishing a simplex media path and session over a terminal using a communication protocol; establishing an additional simplex media path and session over an additional terminal using the communication protocol; and utilizing the simplex media path and session with the additional simplex media path and session to provide full duplex media service between the terminal and the additional terminal. In some embodiments, after establishing the additional simplex media path and session, processing media on the additional terminal. In some embodiments, the communications network is a Push-to-Talk over Cellular (PoC) network and the simplex media path and session and the additional simplex media path and session are Push-to-Talk (PTT) sessions.

### PRIORITY CLAIM TO PROVISIONAL APPLICATION

A claim for priority is hereby made under the provisions of 35 U.S.C. § 119 for the present application based upon U.S. Provisional Application No. 60/799,270, filed on May 10, 2006 which is incorporated herein by reference.

### FIELD OF INVENTION

The present invention relates to methods and systems for providing full duplex Media service by employing using multiple unassociated sessions, each characterized by simplex media transfer and/or processing.

The application of a simplex services enable a variety of full duplex based services as exemplified by call and session processing technologies, including but not restricted to, call conferencing services.

### BACKGROUND

Existing Push-to-Talk over Cellular (PoC) based services and technologies employ Voice over IP (VoIP) technology to deliver a ‘walkie-talkie’ like experience. Many other services utilize similar principles employing other protocols to provide simplex services. For example, SS7 provides simplex services, which may also be enabled within the scope of the present invention. One limitation of PoC technology is that its use and application over VoIP does not provide a more traditional telephony experience for those employing PTT service such as, for example, an extant PTT service instance whereby a plurality of parties can only hear a single speaker within.

A valued aspect of employing full duplex service with multiple media paths between pluralities of parties within an extant call, or session(s) is that media exemplified by, but not exclusively limited to, speech can be heard by all parties to the call including those that are actively speaking. This trait provides a form of feedback to all parties to the call, or session(s) that contributes to the utility of media oriented services. This is one of many motivations for this present invention.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Methods for providing full duplex media service over a communications network employing simplex media paths are presented including: establishing a simplex media path and session over a terminal using a communication protocol; establishing an additional simplex media path and session over an additional terminal using the communication protocol; and utilizing the simplex media path and session with the additional simplex media path and session to provide full duplex media service between the terminal and the additional terminal. In some embodiments, after establishing the additional simplex media path and session, processing media on the additional terminal. In some embodiments, the communications network is a Push-to-Talk over Cellular (PoC) network and the simplex media path and session and the additional simplex media path and session are Push-to-Talk (PTT) sessions. In some embodiments, the PoC network includes: a PoC server for handling communication between the terminal and the additional terminal, where the first terminal and the at least one additional terminal each include: a PoC client for communicating with the PoC server a user interface for providing user input to the PoC system and for providing PoC system output to a user.

In other embodiments, methods for providing a full duplex media service over a Push-to-Talk over Cellular (PoC) network employing multiple Push-to-Talk (PTT) sessions are presented including initiating a PTT session over a terminal using a communication protocol; establishing another PTT session over another terminal using the communication protocol; processing media on the second terminal; processing media on the first terminal; and utilizing the two PTT sessions to provide full duplex media service between the terminals. In some embodiments, the communication protocol is a Session Initiation Protocol (SIP). In some embodiments, initiating the first PTT session includes sending a modified SIP INVITE message to the second terminal, and wherein the establishing the second PTT session is automatically triggered when the second terminal receives the modified SIP INVITE message. In some embodiments, the modified SIP messages include parameters related to full duplex media service features such as a manual require mode parameter for forcing a manual answer on the second terminal, a manual answer override parameter for forcing an auto answer on the first terminal, a talk burst control inactivity timer parameter for configuring a talk burst inactivity timer, and a talk burst control revoke timer parameter for configuring a talk burst control revoke timer. In some embodiments, methods further include establishing an additional PTT session over an additional terminal using the communication protocol; processing media on the at least one additional terminal; and grouping all PTT sessions to provide full duplex media service between all terminals. In some embodiments, terminals include a protocol layer for handling a signaling protocol, a media oriented protocol, and a media control protocol; a media service layer for processing media transferred over the PoC system; a simplex service layer for handling simplex services; and a multiple session service layer for handling full duplex services.

In other embodiments, simplex media service systems configured for providing full duplex services are presented including: a communication network for establishing and maintaining full duplex services, where the communication network is configured to provide simplex media services; terminals for receiving full duplex services, where the terminals include, a protocol layer for handling a signaling protocol, a media oriented protocol, and a media control protocol; a media service layer for processing media transferred over the PoC system; a simplex service layer for handling simplex services; and a multiple session service layer for handling full duplex services. In some embodiments, the communications network includes a 3G Partnership Project (3GPP) wireless IP Multimedia Subsystem (IMS). In some embodiments, the communication network includes a wired Advanced Intelligent Network (AIN). In some embodiments, the signaling protocol utilizes modified SIP messages, where the modified SIP messages include parameters related to full duplex media service such as: a manual require mode parameter for forcing a manual answer on the second terminal, a manual answer override parameter for forcing an auto answer on the first terminal, a talk burst control inactivity timer parameter for configuring a talk burst inactivity timer, and a talk burst control revoke timer parameter for configuring a talk burst control revoke timer.

In other embodiments, methods for providing full duplex media services over a communications network employing simplex media paths with full duplex media service network are presented including: establishing a simplex media path and session over a terminal using a communication protocol; establishing another simplex media path and session over a gateway using the communication protocol, where the gateway is configured to bridge the first communications network with the second communications network, wherein the full duplex media service network includes a full duplex client; and utilizing the simplex media path and sessions to provide the full duplex media service between the terminal and the full duplex client through the gateway. In some embodiments, methods further include: establishing an additional simplex media path and session over another terminal using the communication protocol; utilizing the simplex media path and sessions to provide the full duplex media service between the terminals and the full duplex client through the gateway.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a communication network architecture employing a simplex media service in accordance with embodiments of the present invention;

FIG. 2 is an illustrative representation of a communication network architecture employing a simplex media transfer capability in accordance with embodiments of the present invention;

FIG. 3 is an illustrative representation of protocols that may be utilized to create a full duplex media service by employing multiple sessions with simplex media paths in a PoC communications network in accordance with embodiments of the present invention;

FIG. 4 is an illustrative flow chart of a method by which a terminal may establish a full duplex media service by employing multiple sessions with simplex media paths in a PoC communications network in accordance with embodiments of the present invention;

FIG. 5 is an illustrative flow chart of a method by which a terminal may join an all ready established full duplex media service in accordance with embodiments of the present invention;

FIG. 6 is an illustrative signaling and data flow diagram for establishing full duplex media services between two users employing multiple sessions with simplex media paths in a PoC communications network in accordance with embodiments of the present invention;

FIG. 7 is an illustrative block diagram of a communication system that includes a PoC-FD Gateway for bridging a PoC Client with FD Clients in accordance with embodiments of the present invention;

FIG. 8 is an illustrative block diagram illustrating how a new PoC Client may join the full duplex media service illustrated in FIG. 7 in accordance with embodiments of the present invention;

FIG. 9 illustrates a set of example extensions to PoC signaling protocol through a use of new attributes to existing media types in order to better allow adjustment of the PoC communications network's behavior to a full duplex service experience in accordance with embodiments of the present invention; and

FIG. 10 illustrates a set of exemplary extensions to PoC signaling protocol through a use of a new media type and attributes in order to better allow adjustment of the PoC communications network's behavior to a full duplex service experience in accordance with embodiments of the present invention.

GLOSSARY

| | |
|---|---|
| communications | One or more servers implementing a simplex |
| network | media and session processing service, as could be |
| | exemplified by a plurality of packet switching |
| | and packet processing servers implementing a |
| | PoC service as defined by the Open Mobile |
| | Alliance (OMA). |
| Full duplex | Full duplex service or full duplex Media service |
| service | allows speech to be heard (or media to be |
| | received) by all parties in the call including |
| | those that are actively speaking. |
| IMS - IP Multimedia | IMS is an all-IP wireless system, where data, |
| Subsystem | voice and signaling are all carried as IP packets. |
| IP - Internet Protocol | IP specifies the format of packets an the |
| | addressing scheme in a network. |
| MAO - Manual | MAO enables an originating party to a |
| Answer Override | session to barge through to establish a call |
| | with a recipient party without the recipient |
| | being able to block the establishment of the |
| | session. |
| OMA - Open Mobile | OMA is a neutral, global group that defines and |
| Alliance ™ | promotes open standards for new mobile-phone- |
| | related technologies, focusing specifically on |
| | mobile data services. |
| PoC - Push-to-Talk- | PoC is a service that provides a “walkie-talkie” |
| over-Cellular | service utilizing VoIP technology to a number of |
| | terminals |
| Session | A session is a logical connection between network |
| | endpoints (or terminals) often associated with a |
| | simplex media path between endpoints. Sessions |
| | may be negotiated and managed using an |
| | application layer communications protocol, across |
| | an extant signaling connection. |
| Simplex media path | A simplex media path is a logical connection |
| | between two network endpoints across which |
| | streaming, and non-streaming, mixed and |
| | multiple types of media can be transferred. |
| SIP - Session Initiation | A signaling protocol for Internet conferencing, |
| Protocol | telephony, presence, events notification, and |
| | instant messaging. The current IETF RFC |
| | is 3261. |
| | http://www.ietf.org/rfc/rfc3261.txt?number=3261 |
| Terminal | A terminal is a device within a communications |
| | network, fixed or wireless, which is used by a |
| | network subscriber, user, or other individual |
| | entity to leverage the communications capabilities |
| | of the network. Also known as “User |
| | Equipment.” Examples of a terminal would |
| | include devices able to operate in the role of a |
| | PoC client. The present invention, in some |
| | embodiments, assumes that a subscriber to a |
| | service has a one to one relationship with a |
| | terminal. However a strictly one to one relation- |
| | ship not required for all variations of the present |
| | invention. |
| UE - User Equipment | A terminal (e.g. handset or PC) with the PoC |
| | Client-Application installed. |
| VoIP - Voice over | VoIP is an exemplary of a combination of a |
| Internet Protocol | session signaling protocol and a media transfer |
| | protocol. VoIP is a technology that is used to |
| | transmit media in the form of digital data |
| | packets, over Internet Protocols, as opposed |
| | to using traditional telephone lines or circuit |
| | switched wireless bearers. For the purposes of this |
| | present invention packet protocols and circuit |
| | switched protocols and methods are |
| | indistinguishable. |

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The present invention describes methods by which traits of traditional telephony and call processing or handling (i.e. full duplex service) may be enabled utilizing PoC and/or other VoIP protocols utilizing simplex media paths.

Embodiments of the present invention provides methods by which communications entities, known as terminal devices or simply terminals, employing simplex media transferring and processing, can proffer full duplex media service and, consequently, an interactive experience for users of terminals devices enabled for a PoC and/or VoIP technology. An exemplary embodiment of a communications system comprises a plurality of terminals tailored to communicate with a communications network along with one or more servers implementing a Simplex media and session processing service, as could be exemplified by a plurality of packet switching and packet processing servers implementing a PoC service as defined by the Open Mobile Alliance (OMA). An example of how this might affect users of such a service is that the users are able to communicate in an interactive fashion using a communications network designed to deliver simplex only experiences. For example, one user will be able to listen and speak simultaneously to second user using exactly the same type of network entities as are used for simplex only services.

In one aspect of the invention, implementation of entities required to implement a communications network would remain largely unchanged from that employed to deliver a simplex media experience to users. However, specific optimizations for entities within a communication network might be desirable to optimize a user's experience of full duplex services employed using sessions with simplex media paths. Examples of such optimizations are as follows: not forwarding requests to establish sessions between terminals if either terminal is not available due to an extant session; reducing media latency within the communications network by finding a shortest media path among all participants for each session that builds up a full duplex service; and reducing overall network load by aggregating media paths with same direction and recipient. In other embodiments, the present invention includes terminals implementing clients of a simplex media service. Terminals belonging to subscribers or users wishing to employ the aspects of the present invention will employ terminals implemented over a simplex media service and enhanced to support the characteristics of this present invention. In another aspect, the invention further includes utilization of signaling protocols, or similar, in order to establish additional sessions between devices to enable full duplex communications capabilities, or services, when any simplex media paths and associated sessions are initiated. This utilization negates the need to ‘switch’ or ‘convert’ an extant simplex service instance into one with full duplex characteristics.

### A. ARCHITECTURE

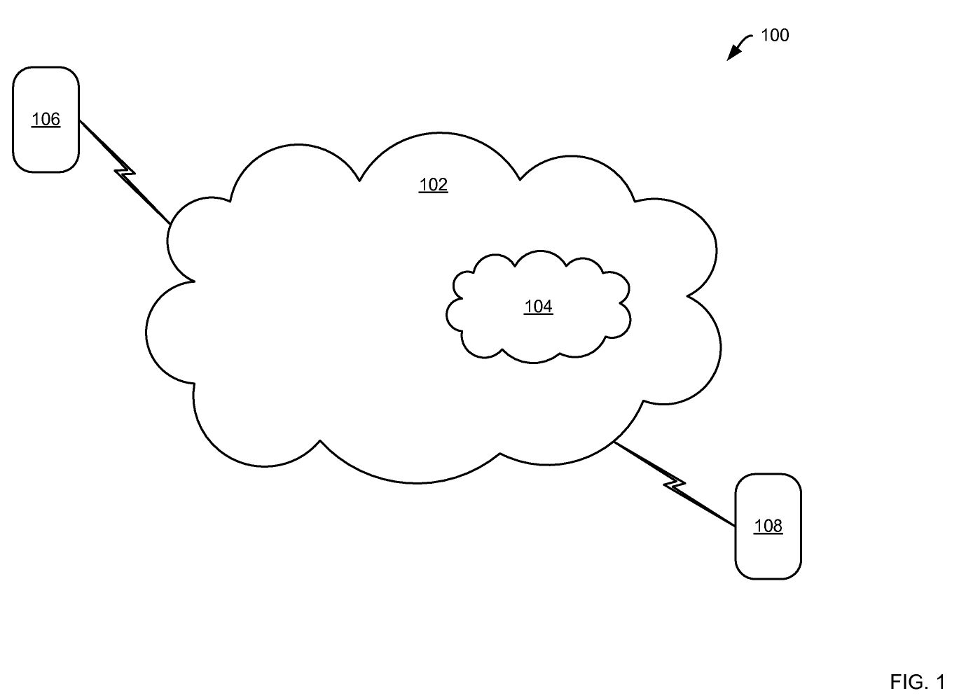

FIG. 1 is an illustrative representation of a communications network architecture 100 employing a simplex media service 104 in accordance with embodiments of the present invention. A number of terminals 106 and 108 may be deployed within communications network 102. In the illustrated embodiment, communications network 102 implements simplex media service 104 transferring, processing, and signaling capabilities to: manage communication resources; manage communication infrastructure; carry media; and control communication paths. As noted above, a simplex media path is a logical connection between two network endpoints across which streaming, and non-streaming, mixed and multiple types of media may be transferred. Communication paths typically consist of those resources provided to transport media between terminal devices and network entities implementing desired services. In some embodiments, a communication network, such as illustrated in FIG. 1 includes IP Multimedia Subsystem (IMS), as defined by the wireless industry's 3G Partnership Project (3GPP). An IMS is an all-IP wireless system, where data, voice and signaling are all carried as IP packets. In addition, wire line based enhanced services networks such as the Advanced Intelligent Network (AIN) may be utilized without limitation without departing from the present invention. As such, packet switch protocol domains and circuit switched domains may be utilized without limitation in embodiments described herein.

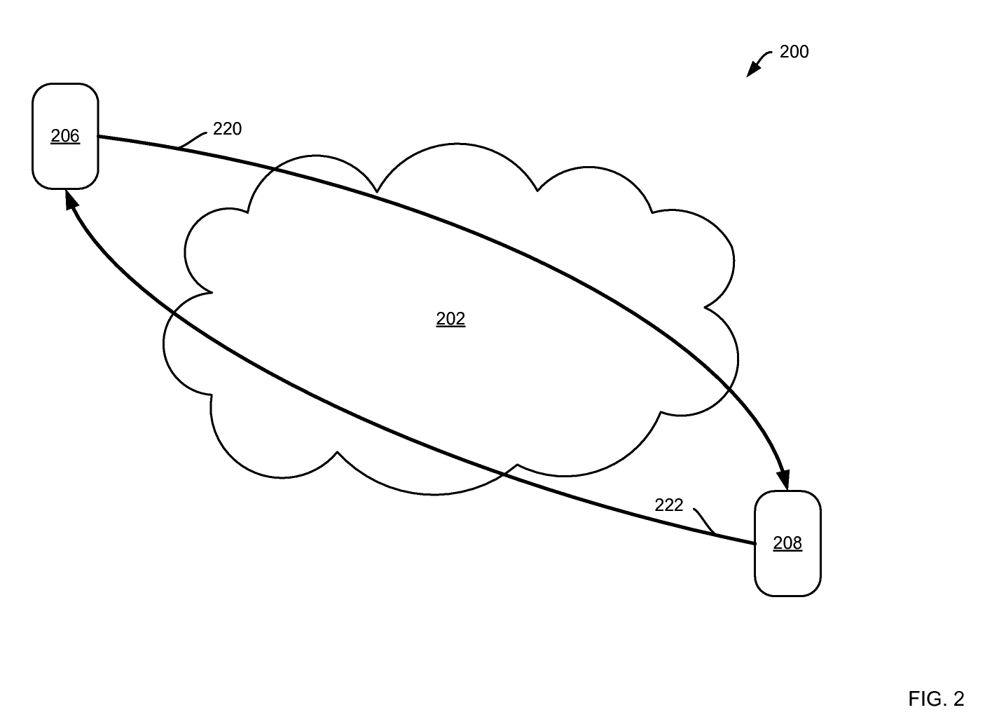

FIG. 2 is an illustrative representation of a communication network architecture 200 employing a simplex media transfer capability in accordance with embodiments of the present invention. As above, a number of terminals 206 and 208 may be deployed across communications network 202. Here, however, multiple sessions and simplex media paths (220 and 222) are utilized to provide full duplex service. Communication network 202, in the illustrated embodiment, acts only as a transport for terminals 206 and 208 (i.e. no network entity interaction at an application level with terminals to implement services). Terminals 206 and 208 are solely responsible for the provisioning and implementing this embodiment. Terminal to terminal interaction is commonly known as a Peer-to-Peer network. Additional explanations of FIG. 2 are described in further detail below.

### B. METHODS OF OPERATION

Embodiments provided herein utilize terminals that are equipped to support simplex media path(s) and/or session based protocol(s) and are tailored to implement applications of those paths and protocols. Thus, implementations enable any number of incoming, and outgoing media paths, and/or a number of sessions. These implementations may be negotiated automatically, or manually under the control of a terminal's user interface without limitation.

In an embodiment, a first operational method includes initiating a first simplex media path and session using a manual answer from an originating party of a session towards a receiving party of a session. The method then requires a second simplex media path and session to be established using automated answering options between the receiving party towards the originating party. An example of this method as applied to SIP protocol employs a “Manual;Require” in an initial INVITE from an originating party of the first simplex media path and a session. A receiving party to the session then employs a Manual Answer Override (MAO) in a second simplex media path and a session instantiation using a subsequent SIP INVITE Message.

In an embodiment, a second operational method includes utilizing automatic responses to a tailored SIP INVITE message(s), exemplified by, but not limited to, SIP Session Description Protocol modifications discussed within the context of the present invention. Automated responses may be utilized to request the initiation of an additional outgoing simplex media path and session to establish a complex media interchange and session(s) implemented as two simplex media paths and two sessions, also known as a full duplex service within the context of this present invention. Likewise, in an extension of this embodiment, automated responses may be further utilized to enable any number of simplex media paths and sessions to create diverse and various services. An example of this method results in an automatic triggering of signaling messages and session establishment at the reception of a SIP INVITE by a receiving party of a first SIP INVITE message. A SIP INVITE message may contain appropriate data as exemplified by additional SIP Session Description Parameters, for the continued exchange of sufficient SIP messages to complete the successful initiation of a second (or more) outgoing session from the receiving party of the initial SIP INVITE.

In an embodiment, a third operational method is presented where terminals invited to a full duplex service and employing embodiments herein may be tailored to ensure that signaling and media path resource allocation of any outgoing simplex media path and session are completed successfully prior to establishing a corresponding incoming media path resource allocation.

In an embodiment, a fourth operational method is presented where playback of ringing indications, alert tones, and other audio/visual indications relating to this present invention or indeed other services implemented by receiving terminals may be terminated in the event that media originating from other entities within an extant session is received.

In an embodiment, a fifth operational method is presented where termination of and/or exiting from all extant session(s) relating to any established simplex media path(s) is initiated and completed in the event that a terminal terminates participation in an established full duplex service. An example of this method includes transmitting, receiving, and processing of SIP BYE signaling messages relevant to any number of existing simplex media paths when a terminal is terminated by the user of a full duplex service. Termination may be achieved by utilizing a terminal user interface or triggered by some other event.

In an embodiment, a sixth operational method is presented where an outbound simplex media path(s) and session(s) may be terminated when a corresponding incoming session no longer exists. An example of this method includes the automatic termination of an outbound extant simplex media path(s), and the transmission of SIP BYE packets when a communications network implementing SIP is employed, as, for example, in an OMA PoC session.

In an embodiment, a seventh operational method is presented in combination with the first operational method described above. In this method, the outbound Simplex Media path and session may be utilized as a communications protocol to initiate establishment of the inbound simplex media path and/or session from another party. Thus, in an example utilizing SIP protocol, initiation of an outgoing simplex media path and session from another party is automatically triggered by sending an Instant Personal Alert signaling message(s) through an extant incoming simplex media path and session utilizing either a standard protocol indication, a tailored protocol indication, or other data to automatically initiate the necessary procedure to establish the outgoing simplex media path and session from another party.

In an embodiment, an eighth operational method is presented that implements a communications gateway between a traditional circuit switched and/or full duplex VoIP media based network and a simplex media and session based network. The method bridges two different communications networks with a provision to integrate and interoperate protocols implemented by each thus providing a seamless full duplex service offering for complex media and session capabilities. An example of this method includes a simplex media and session based service such as OMA PoC employing a communications gateway, comprising a signaling and media transfer, and processing functions. The service may act as a PoC Client to a PoC Server with same characteristics as the other clients. In addition, the service may be further configured to support any number of full duplex service components, as exemplified by a number of sessions and media paths. In this manner, the service may act on behalf of multiple Circuit Switched or full duplex VoIP call participants in an instantiation of single or multiple full duplex service(s).

In an embodiment, a ninth operational method is presented that establishes sessions for the purposes of this present invention that are provisioned for entities or parties other than the terminal originating any pre-existing session(s). Such methods may be configured to employ a control signal within: a session signaling protocol, message(s) associated with media control, media path messages, or side band messages related to other protocol(s) employed by outside parties. These control signals may be utilized to initiate their respective outgoing simplex media path(s) in order to complete the establishment of and participation in a full duplex service. An example of this method is the establishment of outgoing group sessions to all other participants in a session based on a Session Participants field in the Talk Burst Control Protocol (TBCP) Floor Taken message of the incoming session as setup by the originating party of the session. Another example method is the establishment of outgoing group call to all other participants in a session based on an Invited Parties Identity Information field in a SIP INVITE or SIP REFER of the incoming session as setup by the originating party of the session.

In an embodiment, a tenth operational method is presented that adds a new terminal to each of the number of sessions and media paths used for an implementation of a full duplex service based on receiving additional requests to participate in an existing session(s) and media paths complicit with the session(s). Terminals being added may trigger control signaling that configures each added terminal with the necessary number of modified sessions and media paths between the communications network as a direct result of: a new terminal being admitted into the extant session(s); a terminal within an extant session inviting a new terminal into the session(s); or a terminal previously removed from an extant session being readmitted to existing sessions. An example of this method includes the addition of a new participant to extant sessions by employing control signals such as SIP INVITE, or SIP REFER messages for each of the existing sessions. For example, messages may be sent either from participating terminals, from joining terminals, and from rejoining terminals. All media paths being employed may be established for a new participant of each of the sessions by first adding the new participant to the extant session(s) that will be used for inbound media. Having established inbound media paths the new participating terminal will then establish outgoing session(s) as appropriate utilizing additional INVITE or REFER messages.

In an embodiment, an eleventh operational method is presented that adds a new terminal to an single outgoing media path based on receiving an updated conference state package for an existing incoming session(s) that states the identity of the new terminal being added. An example of this method includes the use of a control event to activate the augmentation of multiple session and media paths to include new terminals being added to extant sessions. Within the context of the present example, the use of event packages within SIP can be used to trigger terminals, other communications network observing entities, or actively controlling entities, to initiate the augmentation of extant simplex media paths and sessions, and to instantiate any number of session(s) subsequent to the initial session being established as described above for the tenth operational method. In this manner, a correct number of media paths and session for the extant session and the new participant(s) may be created.

In an embodiment, a twelfth operational method is presented where terminals may be configured to augment control messages with information, parameters, and negotiated arguments related to service features. Session and Media path characteristics employed within this embodiment may be tailored to better serve the demands of a full duplex service. This method employs aspects of modified SIP control messages to enhance existing characteristics of service description protocols with information related to the characteristics of any service being implemented using this present invention. Using this method a terminal(s) can alter characteristics of features such as Talk Burst Control used by the Simplex Media and Session services to tailor said services to the requirements of full duplex services. An example of this method includes the addition of a Talk Burst Control Inactivity Timer data or information item within a SIP Session Description Protocol (SDP) tailored as described within the present method, and described in further detail below. An additional example of this method includes the addition of a Talk Burst Control Revoke Timer data or information item within a SIP Session Description Protocol (SDP) tailored as described within the present method and transmitted from a terminal to the communications network. In a SIP enabled network, such as IMS, sessions tailored by the presence of SDP items exhibit characteristics of long lived media and session components such that the present invention can be properly provisioned to provide uninterrupted media flow and control for a period of time determined by terminals operating extant session(s). Another example of this method offers a means by which terminals can employ tailored messages with information concerning characteristics related to a Simplex Session and Media service where the tailored messages conform to existing standards such as exemplified by IMS and OMA PoC, while at the same time convey parameters, arguments and other important information related to modification of the characteristics of existing standardized simplex media and session services should said services offer these abilities. For example, a full duplex call follow-on request parameter may be utilized to establish a second media path in response to a full duplex request sent by a calling user to a receiving user. Thus sessions and services may be tailored and enhanced in embodiments described herein.

In an embodiment, a thirteenth operational method is presented where a terminal utilizes media processing to remove any audio artifact, visual artifact, or any other artifact of the media being transported across the media path that may be introduced to the media as a result of orthogonal sessions and associated media simultaneously on terminal devices. An example of this method includes a terminal device implementing echo canceling processes to remove echo introduced to a session as a result of using audio in a full duplex fashion. That is, playing and recording audio from an original source of the audio to one or more outgoing audio media path(s) that results in a feedback loop.

### C. EMBODIMENTS

As detailed above, FIGS. 1 and 2 provide simplified architectures by which one skilled in the art can easily envision certain additional examples of communications network and networking topologies and technologies across which this present invention applies without departing from the present invention.

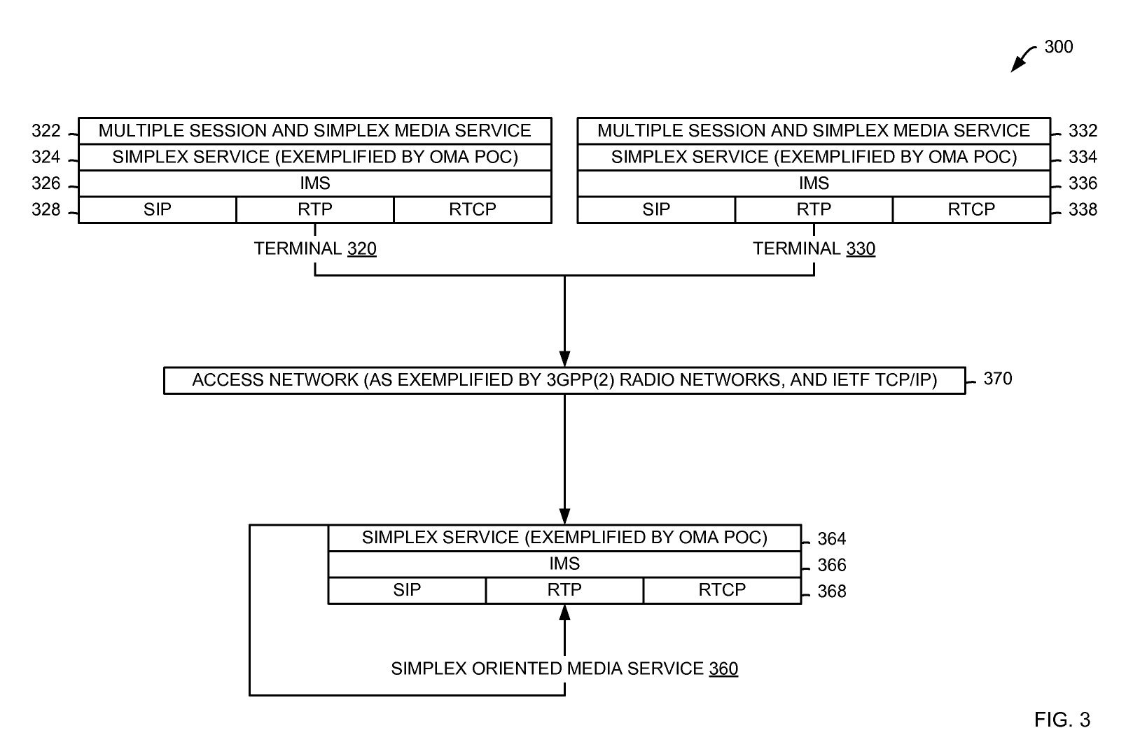

FIG. 3 is an illustrative representation 300 of protocols that may be utilized to create a full duplex media service by employing multiple sessions with simplex media paths in a PoC communications network in accordance with embodiments of the present invention. With respect to the communications network depicted in FIG. 1, FIG. 3 depicts a detailed breakdown of various layers utilized in accordance with embodiments described herein that are related to an Internet Protocol based communications network and corresponding layers of communications network protocols and technologies employed within those embodiments. Thus, transport layer 370 is an example transport layer utilized within a communications network. Transport layer 370 may be common to both network based services and peer-to-peer network based services as detailed for FIGS. 1 and 2 respectively.

In some embodiments, terminals 320 and 330 may be equipped with such equipment and software as required to interact with a network transport including hardware based devices. Hardware based devices may include radio transmission and reception equipment for wireless communications networks and Carrier Sense Multiple Access/Collision Detection equipment for wired communications networks without limitation in embodiments described herein. In addition, software, firmware, or other form of programmable logic as is commonly found within software, include software based technologies such as software defined radio implementations paired with radio hardware or equipment, and TCP/IP in conjunction with Media Access Control for both network transport classes.

Protocols 328, 338, and 368 may include: signaling protocols for transmission of signaling (i.e. SIP Session Signaling); media oriented protocols (i.e. RTP Real-Time Transport Protocol); and media control protocols (i.e. RTCP Real-Time Control Protocol a companion protocol of RTP that is used to maintain quality of service, and service features related to media flow). Those skilled in the art will appreciate that other protocols such as, call signaling protocols exemplified by protocols such as SS7 (System Signaling Number 7) may be utilized as functional equivalents to the SIP protocol without limitation and without departing from the present invention. As noted above, protocols detailed within this figure and accompanying illustrated examples may be utilized within network based services, and peer-to-peer network based services without departing from the present invention.

Further to FIG. 3, the remaining detail will apply to an example network based service. IP multimedia subsystems (IMS) 326, 336, and 366 illustrate standardized applications of communications network protocols for session, media, and media control that are utilized for implementing a simplex media service with characteristics as detailed within embodiments of the present invention. Within the present figures and its associated illustrated examples, IMS represents a standard communications network layer bringing together any number of communications protocols and technologies to provide a platform across all components of a communications network upon which applications and services may be deployed. Simplex services 324, 334, and 364 illustrate standardized network platform and protocols in the form of working services and applications. In some embodiments, a working service relates to an Open Mobile Alliance (OMA) PoC service. OMA PoC service is a simplex media service utilizing a network based service. Services 322, and 332 illustrate layers upon which embodiment of the present invention are deployed within participating terminal devices.

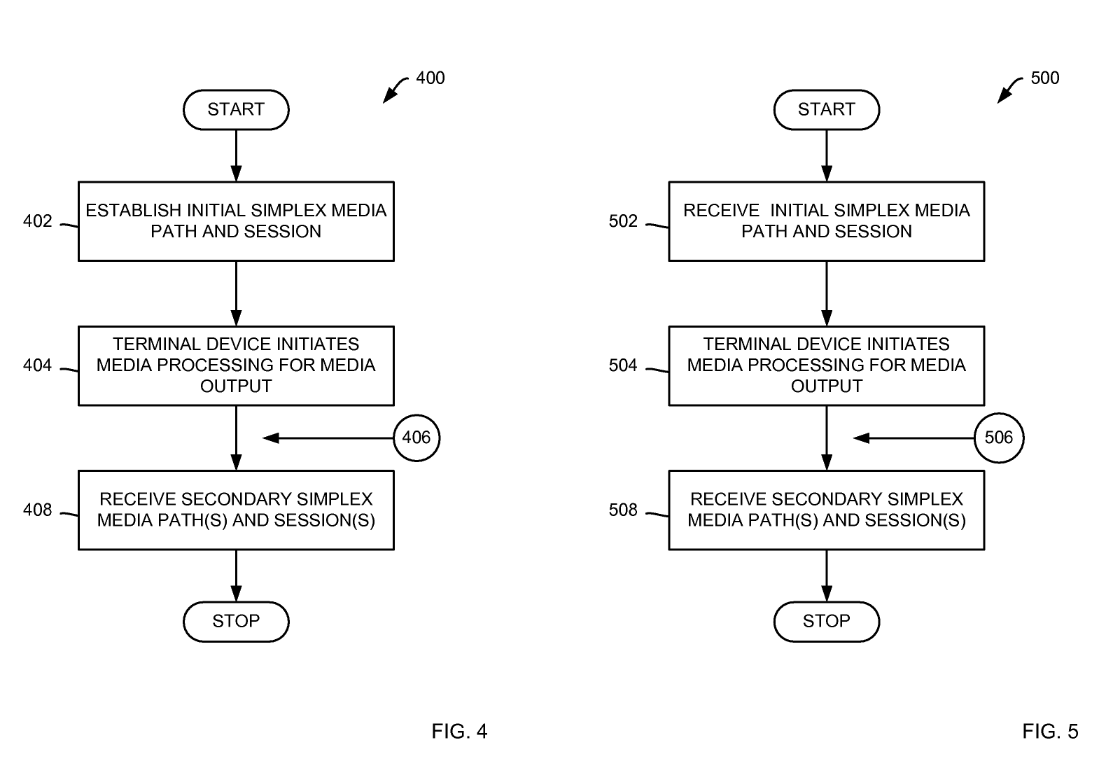

FIG. 4 is an illustrative flow chart 400 of a method by which a terminal may establish a full duplex media service by employing multiple sessions with simplex media paths in a PoC communications network in accordance with embodiments of the present invention. In some embodiments, a user may initiate a session utilizing methods provided herein. As such, at a first step 402, the method establishes an initial outgoing simplex media path and session. Establishing an initial outgoing simplex media path and session is well-known in the art and may be accomplished utilizing any number of methods without departing from the present invention. At a next step 404, the method may optionally initiate any media processing. Media processing may be utilized to manipulate media being processed, played, and recorded by a terminal. For example, in an embodiment, a step 404 may be used to instantiate media mixing devices and active media processing software such as an echo canceller in the case of audio media. At a next step 408, the method establishes any secondary simplex media path(s) and session(s) that are known to be required by the originating terminal as a result of specific knowledge about particular requirements or characteristics of the full duplex service.

In response to a step 402, all terminals participating in the full duplex service may begin to individually establish their outgoing media path(s) and session(s) as necessary to instantiate the full duplex service. A step 406 provides an entry point for secondary incoming media path(s) and session(s) so that the full duplex service logic resident within a terminal device may be readily be notified of new participants, processes, and media. In some embodiments, media is processed as described above for a step 404. The method then ends when full duplex media services are established between terminals using the multiple simplex media paths and sessions. As may be appreciated, embodiments described herein may be configured utilizing a variety of triggers for various steps within FIG. 4. In general, however, the illustrated steps will remain substantially similar across various embodiments employed to establish full duplex services for terminals.

FIG. 5 is an illustrative flow chart 500 of a method by which a terminal may join an all ready established full duplex media service in accordance with embodiments of the present invention. In particular, flow chart 500 represents, in some embodiments, a step 406 of FIG. 4. Thus, in some embodiments, a user may join a session utilizing methods provided herein. As such, at a first step 502, the method receives an initial simplex media path and session of an all ready established session. At a next step 504, the method may optionally initiate any media processing. Media processing may be utilized to manipulate media being processed, played, and recorded by a terminal. For example, in an embodiment, a step 504 may be used to instantiate media mixing devices and active media processing software such as an echo canceller in the case of audio media. At a next step 508, the method establishes any secondary simplex media path(s) and session(s) that are known to be required by the originating terminal as a result of specific knowledge about particular requirements or characteristics of the full duplex service.

In response to a step 502, all terminals participating in the full duplex service may begin to individually establish their outgoing media path(s) and session(s) as necessary to instantiate the full duplex service. As above, a step 506 provides an entry point for secondary incoming media path(s) and session(s) so that the full duplex service logic resident within a terminal device may be readily be notified of new participants, processes, and media. In some embodiments, media is processed as described above for a step 504. The method ends when full duplex media services are established between terminals using the multiple simplex media paths and sessions. As may be appreciated, embodiments described herein may be configured utilizing a variety of triggers for various steps within FIG. 5. In general, however, the illustrated steps will remain substantially similar across various embodiments employed to establish full duplex services for terminals.

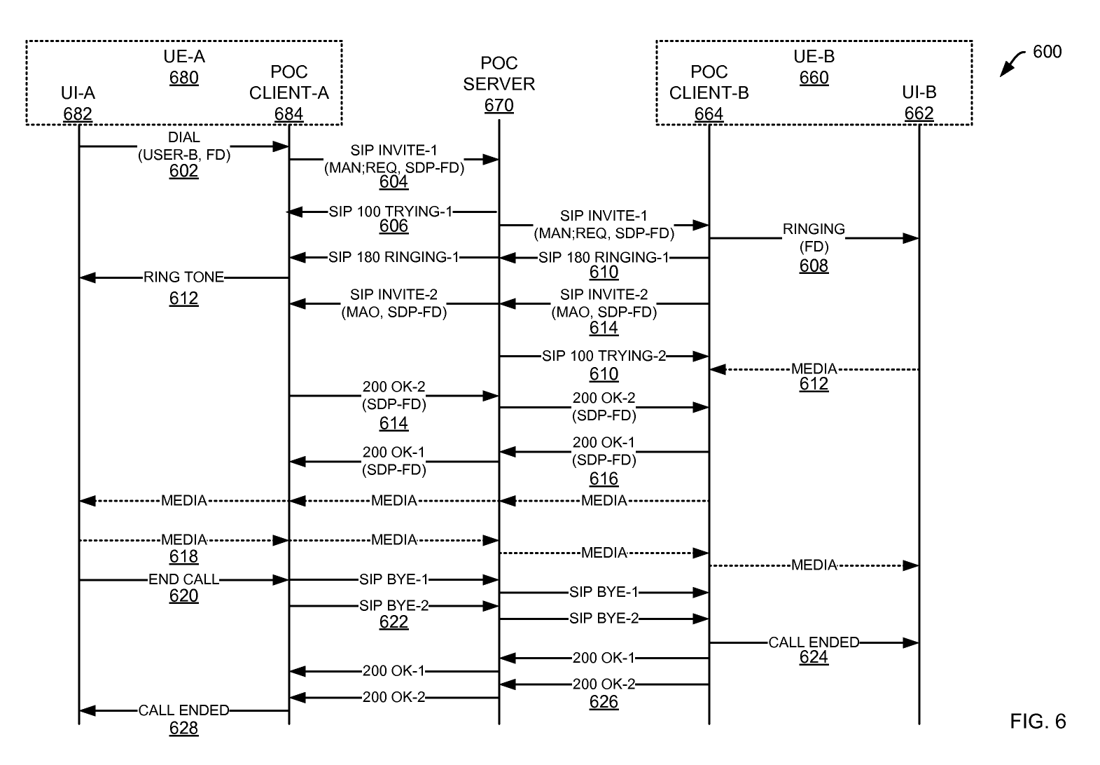

FIG. 6 is an illustrative signaling and data flow diagram 600 for establishing full duplex media services between two users employing multiple sessions with simplex media paths in a PoC communications network in accordance with embodiments of the present invention. The illustrated embodiment enables, in some respects, a traditional full-duplex like telephony experience for User-A and User-B. However, it may be appreciated that, signaling and media flow between PoC Client-A 684 and PoC Client-B 664 are not limited to any single media (i.e. audio media) scenario and may, in some embodiments, encompass establishment of multiple simplex media paths in either direction like any traditional multimedia service without departing from the present invention. As may be appreciated, User Equipment-A (UE-A) 680 may, in embodiments, utilize a User Interface (UI-A) 682 to supply commands to PoC Client-A 684. Likewise, User Equipment-B (UE-B) 660 may, in embodiments, utilize a User Interface (UI-B) 662 to supply commands to PoC Client-B 664. Establishing full duplex service may be initiated by an originating participant (UI-A 682) dialing User B's number and selecting the full duplex (FD) service option. Dialing triggers PoC Client-A 684 to send a SIP INVITE-1 message 604 to PoC server 670 in preparation for establishing a first leg of the full duplex service, i.e. PoC session-1. PoC Client-A 684 appends SIP INVITE-1 message to include full duplex (FD) as a media type in the Session Description Protocol (SDP). In addition, PoC Client-A 684 sets answer mode to Manual Require (Man;Req), which forces a manual answer (i.e. ringing rather than barging) on the terminating side regardless what answer setting PoC Client-B 664 has configured in the PoC Server 670 for PoC Client-A 684. Further, PoC Client-A 684 maintains an implicit floor that is granted to him as an originator of PoC session-1 throughout the lifetime of the full duplex service.

Upon receiving SIP INVITE-1 message 604, the PoC Server 670 may send a SIP 100 Trying message 606 to PoC Client-A 684. PoC Server 670 routes SIP INVITE-1 message 604 as per OMA PoC specification to PoC Client-B 664. When PoC Client-B 664 receives SIP INVITE-1 message 604, PoC Client-B 664 begins a ringing procedure 608 to alert User-B and sends SIP 180 Ringing message 610 back to PoC Client-A 684 through PoC Server 670 as required by a configured Manual Require mode as note above. Upon receiving SIP 180 Ringing message 610, PoC Client-A 684 alerts User-A with a ring tone 612. When PoC Client-B 664 receives SIP INVITE-1 message 604, the FD media parameter indicates to PoC Client-B 664 to automatically initiate a second PoC session (PoC session-2) towards PoC Client-A 684. This second session enables a simultaneous use of simplex media paths in each direction. As such, PoC Client-B 664 sends SIP INVITE-2 message 614 to PoC Client-A 684 via PoC Server 670. SIP INVITE-2 messages includes a request for Manual Answer Override (MAO). MAO will provide an auto answer regardless what answer setting PoC Client-A 684 has configured for PoC Client-B 664 at PoC Server 684 so that ring tones that are usually played when a user receives media may be suppressed. In the same manner that PoC Client-A 684 was required to maintain the implicit floor that was granted as originator of PoC session-1 throughout the lifetime of the full duplex service, PoC Client-B 664 is required to maintain the implicit floor that was granted as originator of PoC session-2 throughout the lifetime of the full duplex service.

When PoC Server 670 routes SIP INVITE-2 message 614 to PoC Client-A 684 as per OMA PoC specification and PoC Server 670 also sends a SIP 100 Trying message 610 to PoC Client-B 664. After receiving SIP INVITE-2 message 614, PoC Client-A 684 responds with 200 OK-2 message 614 for PoC session 2 which is routed to PoC Client-B 664. In some embodiments, User-B may have answered the ringing 608 and responded with a media stream 612 such as a “Hello?” If 200 OK-2 message 614 has not been received, PoC Client-B 664 buffers media stream 612 until 200 OK-2 message 614 has arrived. Once PoC Client-B 664 is assured a media path toward PoC Client-A 684, PoC Client-B 664 sends 200 OK-1 message 616 along with buffered media 612 to PoC Server 670. PoC Server 670 then routes 200 OK-1 message 616 (for PoC session-1) and media stream 612 as per OMA PoC specifications to PoC Client-A 684. Upon receiving media stream 612, PoC Client-A 684 terminates ring tone 612 towards User A and begins to play media stream 612 (i.e. “Hello?”) from User B. User A may now respond with media stream 618. In this manner, a full duplex conversation is created across the two PoC sessions (i.e. PoC session-1 and PoC session-2). User-A and User-B may then converse normally until the end of full duplex service.

Either User-A or User-B may end the full duplex service. This is done by sending two SIP BYE messages (one for PoC session-1 and another one for PoC session-2). In the illustrated example, User-A ends the call 620 whereupon PoC Client-A 684 sends SIP BYE-1 message and SIP BYE-2 message 622 to PoC Server 670. PoC Server 670 routes SIP BYE-1 message and SIP BYE-2 message 622 to PoC Client-B 664 as per OMA PoC specification. PoC Client-B 664 may then send a Call Ended indication 624 to User-B after having received both SIP BYE messages. PoC Client-B 66 sends 200 OK-1 message and 200 OK-2 message 626 to PoC Client-A 684. When PoC Client-A 684 receives both 200 OK messages associated with both SIP BYE messages, PoC Client-A 684 declares a Call Ended 628. This latter approach is selected in order to allow for transitioning from the full duplex service to a simplex PoC service without having to re-establish all PoC sessions. As may be appreciated, illustrated embodiments present one-to-one sessions between PoC clients, however, additional PoC clients may be added without limitation in some embodiments. In those embodiments, additional sessions, may be automatically terminated when original sessions, such as those illustrated, do not exist. In other embodiments, a group session may be triggered for all requested participants based on information in a TBCP FLOOR_TAKEN message sent to all requested participants when a user initiates a group session or when a user is added to an existing session, which may include additional incoming session information or updated conference state package of existing incoming session information.

As mentioned above, in some embodiments, an upgraded service from a simplex PoC service to a full duplex service may be accomplished. Upgraded service can be initiated by User B (the recipient of the existing PoC session-1) at any time by selecting an option to upgrade an existing PoC service (i.e. simplex session) to a full duplex service. In addition, upgraded service may be initiated by User A (the originator of the existing PoC session-1) by sending a SIP Message (in OMA PoC called Instant Personal Alert—IPA) with a FD request indicator to trigger PoC Client-B to initiate a second PoC session (i.e. PoC session-2).

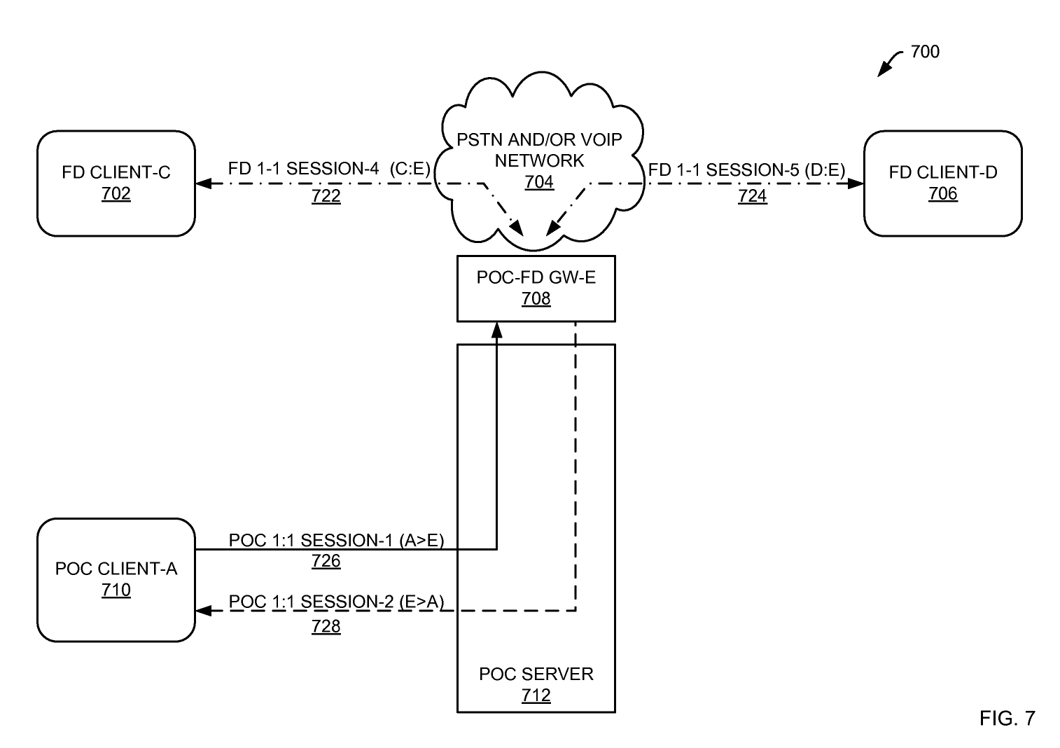

FIG. 7 is an illustrative block diagram of communication system 700 that includes a PoC-FD Gateway-E 708 for bridging a PoC Client 710 with FD Clients 702 and 706 in accordance with embodiments of the present invention. As illustrated FD Clients 702 and 706 are part of a communications network 704, which may be a public switched telephone network (PSTN), or a VoIP network that support full duplex media paths. Thus, FD Client-C 702 may maintain a full duplex session 722 with communications network 704 and FD Client-D 706 may maintain a full duplex session 724 with communications network 704. PoC-FD Gateway-E 708 may be configured to act as a single PoC Client into a PoC communications network as represented by PoC Server 712. Further, PoC-FD Gateway-E 708 may be configured to act on behalf of both FD Client-C 702 and FD Client-D 706 to setup PoC 1-to-1 session-1 726 and PoC 1-to-1 session-2 728 as bearers for the full duplex service. PoC 1-to-1 session-1 726 and PoC 1-to-1 session-2 728, managed by PoC-FD Gateway-E 708, are shared among FD Client-C 702 and FD Client-D 706. That is, the PoC sessions carry media to and from FD Client-C 702 and FD Client-D 706. Incoming media from PoC 1-1 session-1 726 is forked by the PoC-FD Gateway-E 708 before being sent to FD Client-C 702 and FD Client-D 706, while outgoing media from FD Client-C 702 and FD Client-D 706 are mixed at PoC-FD Gateway-E 708 before being sent out on PoC 1-to-1 session-2 728. In this manner, a PoC client may share a similar full duplex experience with other full duplex clients.

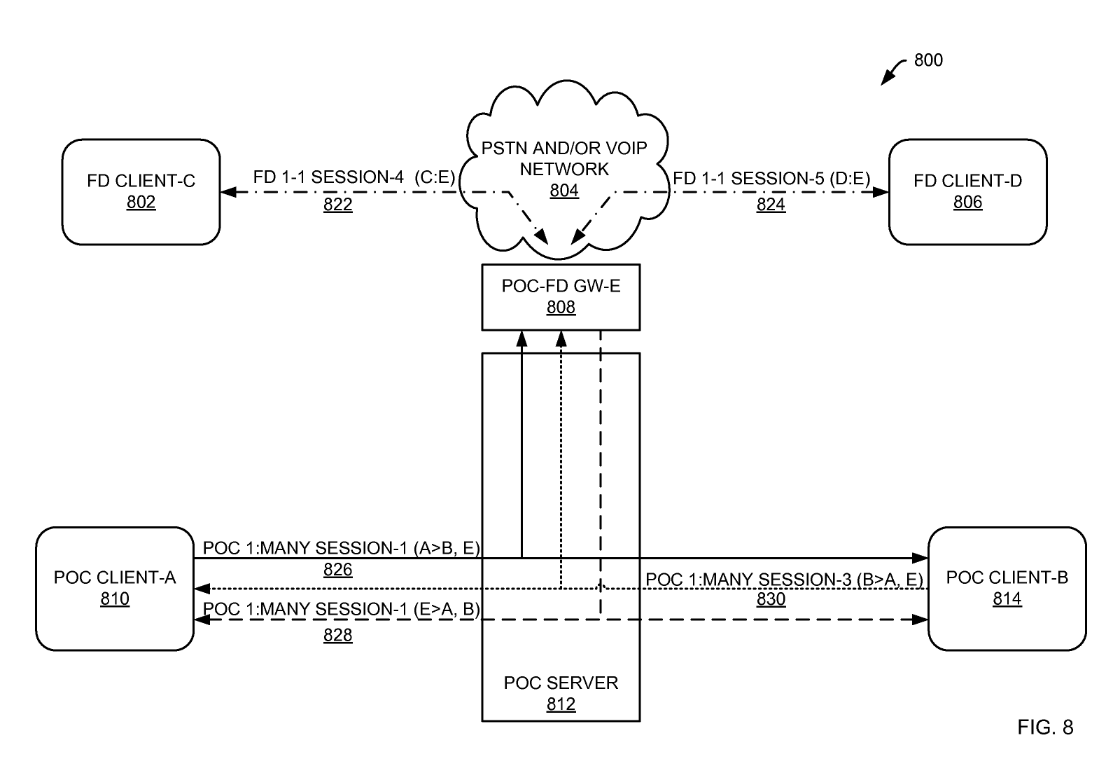

FIG. 8 is an illustrative block diagram illustrating how a new PoC Client may join the full duplex media service illustrated in FIG. 7 in accordance with embodiments of the present invention. In particular, FIG. 8 illustrates modifications to PoC sessions necessary to add an additional PoC client. As above, FD Clients 802 and 806 are part of a communications network 804, which may be a public switched telephone network (PSTN), or a VoIP network that support full duplex media paths. Thus, FD Client-C 802 may maintain a full duplex session 822 with communications network 804 and FD Client-D 806 may maintain a full duplex session 824 with communications network 804. PoC-FD Gateway-E 808 may be configured to act as a single PoC Client into a PoC communications network as represented by PoC Server 812. Further, PoC-FD Gateway-E 808 may be configured to act on behalf of both FD Client-C 802 and FD Client-D 806 to setup PoC 1-to-1 session-1 826 and PoC 1-to-1 session-2 828 as bearers for the full duplex service. PoC 1-to-1 session-1 826 and PoC 1-to-1 session-2 828, managed by PoC-FD Gateway-E 808, are shared among FD Client-C 802 and FD Client-D 806. That is, the PoC sessions carry media to and from FD Client-C 802 and FD Client-D 806. Incoming media from PoC 1-1 session-1 826 is forked by the PoC-FD Gateway-E 808 before being sent to FD Client-C 802 and FD Client-D 806, while outgoing media from FD Client-C 802 and FD Client-D 806 are mixed at PoC-FD Gateway-E 808 before being sent out on PoC 1-to-1 session-2 828. In this manner, a PoC client may share a similar full duplex experience with other full duplex clients.

A second PoC client, PoC Client-B 814 may be invited to join an ongoing full duplex service using the standard procedures to add user as per OMA PoC specification (i.e. by using SIP REFER). Either PoC Client-A 810 or PoC-FD Gateway-E 808 may initiate an add user procedure in a PoC system utilizing the PoC-session originated by either PoC Client-A 810 or PoC-FD Gateway-E 808. Furthermore, in some embodiments, PoC-FD Gateway-E 808 may act as a proxy for FD Client-C 802 and FD Client-D 806 for adding a user by providing the capability to add a user through an Interactive Voice Response function or a web-based conference control interface.

In one embodiment, PoC Client-A 810 adds PoC Client-B 814 to the established FD service by sending a SIP REFER message associated to its outgoing PoC session-1 826 with an SDP media parameter set to full duplex. This parameter triggers PoC Client-B 814 to respond appropriately as described in FIG. 6 above to establish outgoing PoC session-3 830 with PoC Client-A 810 as recipient. PoC-FD Gateway-E 808 will discover through a conference event state package (SIP NOTIFY) from PoC session-1 826 that PoC Client-B 814 has joined PoC session-1 826. This discovery will, in turn, trigger PoC-FD Gateway-E 808 to invite PoC Client-B 814 to PoC session-2 828 that PoC-FD Gateway-E 808 originated. PoC Client-B 814 may then invite PoC-FD Gateway-E 814 to PoC session-3 830, which PoC Client-B 814 originated. A result is that PoC 1-to-1 session-1 826 and PoC 1-to-1 session-2 828 are now upgraded from a 1-to-1 session to 1-to-many session. As may be seen, PoC session-3 830 is configured as a new 1-to-many session. As may be appreciated, additional sessions may be grouped as additional PoC clients are added to provide full duplex service among PoC clients and FD clients. In addition, in one embodiment, additional sessions, such as PoC session-3 830 may be automatically terminated when original PoC sessions such as PoC session-1 826 and PoC session-2 828 do not exist. This may occur when a PoC session is dropped for any reason known in the art. Any required modifications to FD 1-to-1 session-4 822 and to FD 1-to-1 session-5 824 resulting from joining PoC Client-B 814 are outside the scope of this invention. However, in some embodiments, no modifications are required for FD 1-to-1 session-4 822 and FD 1-to-1 session-5 824.

In another embodiment, PoC Client-B utilizes the Invited Parties Identity Information if included in a SIP REFER sent for PoC session-1. In other embodiments, PoC Client-B utilizes the Session Participants Option if sent in the Talk Burst Taken message as part of the OMA PoC User Plane initiation for PoC session-1. In another embodiment, the same PoC session topology as shown in FIG. 8 also applies when PoC Client-B joins a full duplex service without receiving an invitation. For example, in a PoC chat groups as PoC session-1, 2 and 3 or in an Ad Hoc session where PoC Client-B has participated at least once in a previous session, no invitation is required. In both these examples, PoC Client-B has pre-existing knowledge of the group identity of at least one of PoC session-1 or PoC session-2 and can initiate a rejoin independently without receiving an initial SIP REFER from PoC Client-A or from PoC-FD Gateway-E. The subsequent dynamic modification to PoC session-1 & PoC session-2 as well as the establishment and augmentation of PoC session-3 follows the same procedures as for the scenario of “adding user” described above.

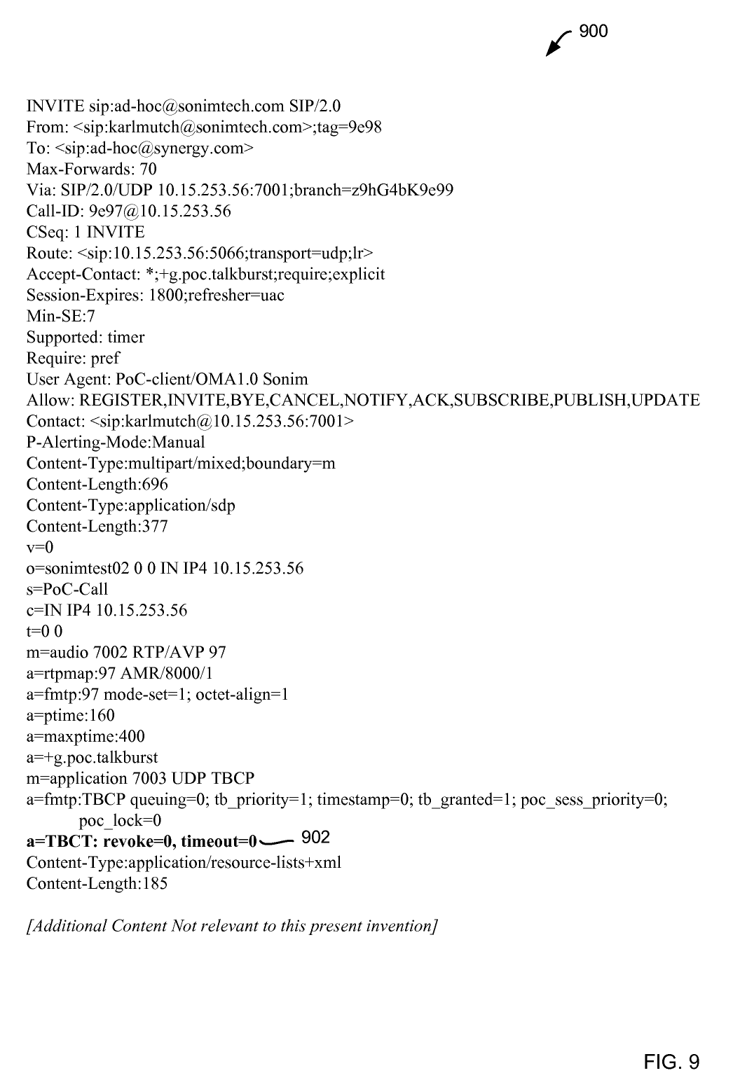

FIG. 9 illustrates a set of example extensions to PoC signaling protocol through a use of new attributes to existing media types in order to better allow adjustment of the PoC communications network's behavior to a full duplex service experience in accordance with embodiments of the present invention. In particular, FIG. 9 illustrates an example modified SIP INVITE message 900 using Session Initiation Protocol (SIP) and Session Description Protocol (SDP) in accordance with the twelfth operational method as described above. As noted above, a twelfth operational method provides that terminals may be configured to augment control messages with information, parameters, and negotiated arguments related to service features. In this example, the Talk Burst Control Inactivity Timer and the Talk Burst Control Revoke Timer are illustrated within a SIP session initiation and invitation request. In this embodiment, the standard SDP attributes field 902 is shown to extend the session initiation request with data as described within method twelve. This can be seen with the addition of the “a=TBCT” attributes (Talk Burst Control Timers). In some embodiments, the Talk Burst Control Inactivity Timer and the Talk Burst Control Revoke Timer may be disabled to provide for an uninterrupted session between participants. This may be particularly useful where an initiator of a session does not often speak.

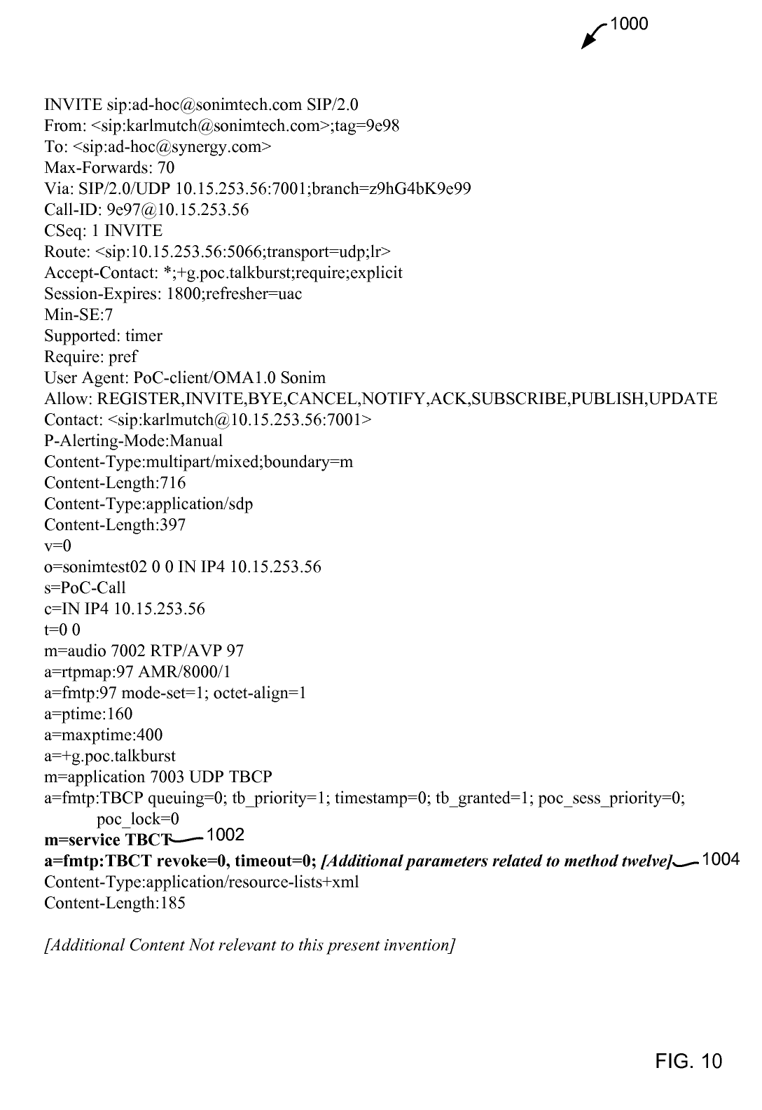

FIG. 10 illustrates a set of exemplary extensions to PoC signaling protocol through a use of a new media type and attributes in order to better allow adjustment of the PoC communications network's behavior to a full duplex service experience in accordance with embodiments of the present invention. As for FIG. 9, FIG. 10 illustrates an example modified SIP INVITE message 1000 using Session Initiation Protocol (SIP) and Session Description Protocol (SDP) in accordance with the twelfth operational method as described above. Those skilled in the art will understand that multiple options are available for extension of the SDP to contain the relevant data for this present invention, including but not limited to, the addition of a new media type (m) 1002 and the simultaneous use of the “a=fmtp:” attribute 1004, as illustrated herein.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the abstract is provided herein for convenience and should not be employed to construe or limit the overall invention, which is expressed in the claims. Still further, unless explicitly stated, any method embodiments described herein are not constrained to a particular order or sequence. It is therefore intended that the following appended claims be interpreted as including all such alterations, permutations, and equivalents as fall within the true spirit and scope of the present invention.

What is claimed is:

1. A method for providing a full duplex media service over a communications network employing simplex media paths, the method comprising:
establishing a first simplex media path and session over a first terminal using a communication protocol;
establishing the at least one additional simplex media path and session over at least one additional terminal using the communication protocol; and
utilizing the first simplex media path and session with the at least one additional simplex media path and session to provide the full duplex media service between the first terminal and the at least one additional terminal.

2. The method of claim 1 further comprising:
after establishing the first simplex media path and session, processing media on the first terminal;
after establishing the at least one additional simplex media path and session, processing media on the at least one additional terminal.

3. The method of claim 1 wherein the communication protocol is IP multimedia subsystem (IMS).

4. The method of claim 1 wherein the communications network is a Push-to-Talk over Cellular (PoC) network and wherein the first simplex media path and session and the at least one additional simplex media path and session are Push-to-Talk (PTT) sessions.

5. The method of claim 4 wherein the PoC network includes:
a PoC server for handling communication between the first terminal and the at least one additional terminal.

6. The method of claim 5 wherein the first terminal and the at least one additional terminal each include:
a PoC client for communicating with the PoC server; and
a user interface for providing user input to the PoC system and for providing PoC system output to a user.

7. The method of claim 1 wherein the communications protocol is selected from the group consisting of: Session Initiation Protocol (SIP), Real-Time Transport Protocol (RTP), and Real-Time Control Protocol (RTCP).

8. The method of claim 2 wherein the media is selected from the group consisting of: audio data, text data, image data, and video data.

9. The method of claim 1 wherein the wherein the first simplex media path and session and the at least one additional simplex media path and session are Voice-over-IP (VoIP) sessions.

10. A method for providing a full duplex media service over a Push-to-Talk over Cellular (PoC) network employing multiple Push-to-Talk (PTT) sessions, the method comprising:
initiating a first PTT session over a first terminal using a communication protocol;
establishing a second PTT session over a second terminal using the communication protocol;
processing media on the second terminal;
processing media on the first terminal; and
utilizing the first PTT session and the second PTT session to provide the full duplex media service between the first terminal and the second terminal.

11. The method of claim 10 wherein the communication protocol is a Session Initiation Protocol (SIP).

12. The method of claim 11 wherein the initiating the first PTT session includes sending a modified SIP INVITE message to the second terminal, and wherein the establishing the second PTT session is automatically triggered when the second terminal receives the modified SIP INVITE message.

13. The method of claim 12 wherein the modified SIP messages include parameters related to full duplex media service features.

14. The method of claim 13 wherein the parameters are selected from the group consisting of: a manual require mode parameter for forcing a manual answer on the second terminal, a manual answer override parameter for forcing an auto answer on the first terminal, a talk burst control inactivity timer parameter for configuring a talk burst inactivity timer, and a talk burst control revoke timer parameter for configuring a talk burst control revoke timer.

15. The method of claim 14 wherein the talk burst control inactivity timer and the talk burst control revoke timer are disabled to provide uninterrupted media flow between the first terminal and the second terminal across the first PTT session and the second PTT session.

16. The method of claim 14 further comprising:
establishing at least one additional PTT session over at least one additional terminal using the communication protocol;
processing media on the at least one additional terminal; and
grouping the first PTT session, second PTT session, and the at least one additional PTT session to provide the full duplex media service between the first terminal, the second terminal, and the at least one additional terminal.

17. The method of claim 16 wherein the PoC network includes:
a PoC server for handling communication between the first terminal, the second terminal, and the at least one additional terminal, wherein the first terminal, the second terminal, and the at least one additional terminal each include:
a PoC client for communicating with the PoC server; and
a user interface for providing user input to the PoC system and for providing PoC system output to a user.

18. The method of claim 10 wherein the media is selected from the group consisting of:
audio data, text data, image data, and video data.

19. The method of claim 16 wherein the first terminal, the second terminal and the at least one additional terminal each include:
a protocol layer for handling a signaling protocol, a media oriented protocol, and a media control protocol;
a media service layer for processing media transferred over the PoC system;
a simplex service layer for handling simplex services; and
a multiple session service layer for handling full duplex services.

20. the method of claim 19 wherein the signaling protocol is System Signaling Number 7 (SS7).

21. The method of claim 14, wherein a 200 OK message is sent by the second terminal in response to the modified SIP INVITE when a second terminal user responds to a first terminal user's invitation to join the first PTT session.

22. The method of claim 14, the manual answer override parameter is configured to suppress a ring tone to a first terminal user by the first terminal to a first terminal user when receiving media from the second terminal.

23. The method of claim 14, wherein the parameters further include a full duplex call follow-on request parameter configured to delay the second media path until the first terminal sends the modified SIP INVITE requesting the full duplex media service.

24. The method of claim 10, wherein a first PTT session SIP BYE message and a second PTT session SIP BYE message are sent by a terminating one of the first terminal user and the second terminal user when the terminating one terminates the full duplex media service.

25. The method of claim 16, wherein the at least one additional PTT session is automatically terminated if the first PTT session and the second PTT session do not exist.

26. The method of claim 16 wherein the at last one additional PTT session is triggered on receipt of a TBCP FLOOR_TAKEN message by the at least one additional PTT session.

27. A simplex media service system configured for providing full duplex services, the system comprising:
a communication network for establishing and maintaining the full duplex services, wherein the communication network is configured to provide simplex media services;
at least two terminals for receiving the full duplex services, wherein the at least two terminals include,
a protocol layer for handling a signaling protocol, a media oriented protocol, and a media control protocol;
a media service layer for processing media transferred over the PoC system;
a simplex service layer for handling simplex services; and
a multiple session service layer for handling full duplex services.

28. The system of claim 27 wherein the communication network includes a 3G Partnership Project (3GPP) wireless IP Multimedia Subsystem (IMS).

29. The system of claim 27 wherein the communication network includes a wired Advanced Intelligent Network (AIN).

30. The system of claim 27 wherein the communications network is a peer-to-peer network.

31. The system of claim 27,
wherein the signaling protocol utilizes modified SIP messages,
wherein the modified SIP messages include parameters related to full duplex media service, and
wherein the parameters are selected from the group consisting of: a manual require mode parameter for forcing a manual answer on the second terminal, a manual answer override parameter for forcing an auto answer on the first terminal, a talk burst control inactivity timer parameter for configuring a talk burst inactivity timer, and a talk burst control revoke timer parameter for configuring a talk burst control revoke timer.

32. A method for providing a first full duplex media service over a first communications network employing simplex media paths with a second full duplex media service over a second communication network, the method comprising:
establishing a first simplex media path and session over a first terminal using a communication protocol;
establishing a second simplex media path and session over a gateway using the communication protocol, wherein the gateway is configured to bridge the first communications network with the second communications network, wherein the second communications network includes at least one full duplex client; and
utilizing the first simplex media path and session and the second simplex media path and session to provide the full duplex media service between the first terminal and the at least one full duplex client through the gateway.

33. The method of claim 32 further comprising:
establishing a third simplex media path and session over a second terminal using the communication protocol;
utilizing the first simplex media path and session, the second simplex media path and session, and the third simplex media path and session to provide the full duplex media service between the first terminal, the second terminal and the at least one full duplex client through the gateway.

34. The method of claim 33 wherein the first communications network is a Push-to-Talk over Cellular (PoC) network and wherein the first simplex media path and session, the second simplex media path and session, and the third simplex media path and session are Push-to-Talk (PTT) sessions.

35. The method of claim 34 wherein the PoC network includes:
a PoC server for handling communication between the first terminal, the second terminal, and the gateway.

36. The method of claim 32 wherein the gateway is configured to act as a proxy for the at least one full duplex client.
